(19) United States
(12) Patent Application Publication
(10) Pub. No.: US 2022/0225624 A1
(43) Pub. Date: Jul. 21, 2022

(54) FLAVOR INJECTOR

(71) Applicant: YUYAO WANDAIFU BARBECUE TOOLS FACTORY, Yuyao City (CN)

(72) Inventor: Niejun YANG, Yuyao City (CN)

(21) Appl. No.: 17/153,046

(22) Filed: Jan. 20, 2021

(51) Int. Cl. A22C 17/00

(52) U.S. Cl. CPC A22C 17/0053; A23L 13/70

(57) ABSTRACT

The utility model discloses a flavor injector. The flavor injector includes: a shroud tube, a storage tube, a sealing cap, a pushing rod, and a needle connector; wherein one end of the shroud tube is detachably or fixedly connected to the needle connector; the storage tube is sealingly fixed inside the shroud tube via the needle connector and the sealing cap; the sealing cap is provided with a through hole allowing the pushing rod to be pushed or pulled; one end of the pushing rod is passable through the through hole and is disposed inside the storage tube; and one end of the pushing rod extending into the storage tube is provided with a sealing plug that is detachably or fixedly connected thereto. Parts of the flavor injector according to the utility model may be separately cleaned in a detachable fashion, which solves the problem of flavor residues.

### TECHNICAL FIELD

The utility model relates to flavor injectors, and, in particular, to a flavor injector which is conveniently cleanable.

### BACKGROUND

During cooking, people generally need to brine meat in advance with flavors, such that the flavors permeate into muscle tissues to enhance cooking flavor. Such treatment of the meat takes long, and only a small amount of flavors permeate into the meat. Especially, if such treatment is not carried out for the meat for a sufficient time period, the flavors may fail to permeate into the meat. In addition, during baking, saltiness inside the food under baking generally fails to reach an edible requirement, especially, for large foods, such as, whole chickens, fishes or the like. As such, the baked food is poor in flavor and taste. Besides, for most foods, it is not recommended to cut the foods before baking, in case of affecting appearance of the foods.

For better injection of the flavors into the food, generally an injector is used to inject the flavors into the food before cooking and baking. Conventional flavor injectors are the same as or similar to the injectors for injecting medicines into human or animal bodies in the medical field. However, after use, the flavor injector fails to be thoroughly cleaned. As a result, transferring of the odor may be caused when the injector is used for a next time, and in addition, the flavor residues may be spoiled when left for a long period of time, and thus latent food safety risks may be caused.

### SUMMARY

To overcome the defect in the related art, the utility model provides a flavor injector which is conveniently cleanable.

To achieve the above object, the utility model provides a flavor injector. The flavor injector includes: a shroud tube, a storage tube, a sealing cap, a pushing rod, and a needle connector; wherein one end of the shroud tube is detachably or fixedly connected to the needle connector; the storage tube is sealingly fixed inside the shroud tube via the needle connector and the sealing cap; the sealing cap is provided with a through hole allowing the pushing rod to be pushed or pulled; one end of the pushing rod is passable through the through hole and is disposed inside the storage tube; and one end of the pushing rod extending into the storage tube is provided with a sealing plug that is detachably or fixedly connected thereto.

With the above technical solution, the storage tube is sealed within the shroud tube by the sealing cap and the needle connector, the pushing rod is detachably connected to the sealing plug, and the shroud tube is detachably connected to the needle connector. In this way, parts of the flavor injector according to the utility model may be separately cleaned sufficiently and thoroughly in a detachable fashion, which solves the problem of transferring of the odor or latent food safety risks due to flavor residues.

Further, the storage tube is made of a transparent or semi-transparent material; and an observation hole for observation of the storage tube is disposed in a side wall of the shroud tube. With the above configuration of the observation hole in cooperation with the transparent or semi-transparent storage tube, a user may in real time observe flavors inside the flavor injector when injecting the flavors.

Further, an annular stage is disposed on a side wall of the needle connector; a limiting stage is disposed at a position of the shroud tube corresponding to the annular stage; and the needle connector is fixedly connected to the shroud tube under engagement between the annular stage and the limiting stage. With the above configuration, when cleaning the injector, the user may quickly take the needle connector out of the shroud tube, and sufficiently clean the bottom portion of the shroud tube.

Further, an annular boss is disposed on a top portion of the needle connector; a lower sealing ring is sleeved onto the annular boss; the lower sealing ring is disposed between the needle connector and the storage tube; an upper sealing ring is disposed between the sealing cap and the storage tube; the upper sealing ring is sleeved onto the pushing rod; an annular stage is disposed on a bottom portion of the upper sealing ring; and an outer diameter of the annular stage is the same as an inner diameter of the storage tube. With the above configuration, the annular boss positions the lower sealing ring, thereby preventing a shift due to an over-great vacuum pressure during use. The upper sealing ring and the lower sealing ring cooperate with each other to seal the storage tube, thereby preventing leakage of the flavors.

Further, the through hole of the sealing cap is provided with an annular reinforcing stage; an inner side wall of the sealing cap is provided with a female thread; and a male thread mating with the female thread is disposed at a position of the shroud tube corresponding to the sealing cap. With the above configuration, the reinforcing stage increases a contact area between the through hole and the pushing rod, thereby preventing the pushing rod from shifting during pushing.

Further, retaining lugs are symmetrically disposed on an outer side wall of the sealing cap; wherein an arc surface is defined on a bottom portion of the retaining lug. With the above configuration, the retaining lug and the arc surface facilitate suctioning and injecting the flavors by the user.

Further, a pressing handle is disposed at one end of the pushing rod not extending into the storage tube; wherein a top portion of the pressing handle is a curved surface that protrudes at two ends but is recessed in a middle thereof, and a reinforcing curved surface is defined at both ends of the pressing handle. With the above configuration, the curved surface and the reinforcing curved surface facilitate suctioning and injecting the flavors by the user.

Further, a female thread connected to a needle is disposed on a bottom portion of the needle connector. The needle connector is thread-engaged with the needle, thereby facilitating disassembly and meanwhile ensuring stability of the needle while injecting the flavors.

Further, the pushing rod includes an inner tube and an adjusting tube; one end of the pushing rod is fixedly connected to the sealing plug, and the other end of the pushing rod is fixedly connected to a connecting sleeve beneath the pressing handle via thread engagement; wherein an adjusting rod sleeve is disposed on the inner tube; and a relative pressure of the adjusting tube against the sealing plug is adjusted by adjusting a connection distance between the connecting sleeve and the inner tube. With the above configuration, smoothness of suctioning and injecting the flavors is adjusted by adjusting a relative pressure of the adjusting tube against the sealing plug.

### BRIEF DESCRIPTION OF THE DRAWINGS

FIG. 1 is a schematic perspective view of a flavor injector;

FIG. 2 is a schematic exploded view of the flavor injector; and

FIG. 3 is a sectional view of the flavor injector.

### DETAILED DESCRIPTION

Exemplary solutions of the utility model are further described with reference to the accompanying drawings.

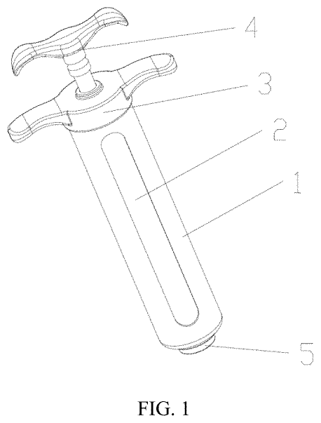

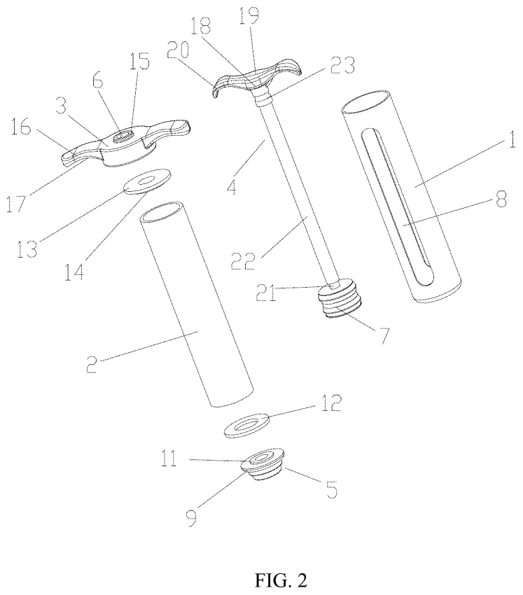

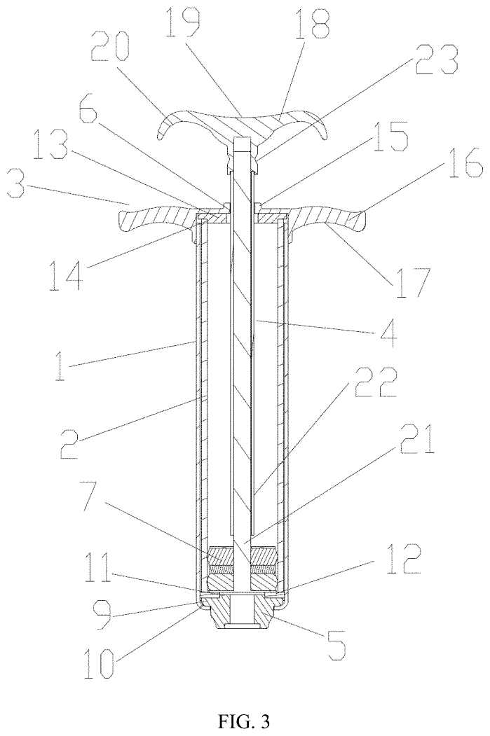

As illustrated in FIG. 1 to FIG. 3, a flavor injector includes: a shroud tube 1, a storage tube 2, a sealing cap 3, a pushing rod 4, and a needle connector 5.

One end of the shroud tube is detachably or fixedly connected to the needle connector. In an optional solution of the utility model, an annular stage 9 is disposed on a side wall of the needle connector; a limiting stage 10 is disposed at a position of the shroud tube corresponding to the annular stage; and the needle connector is fixedly connected to the shroud tube under engagement between the annular stage and the limiting stage. Nevertheless, the shroud tube may also be fixed to the needle connector by virtue of a locking slot or a latch, or by virtue of engagement between female threads and male threads inside the material.

The storage tube is sealingly fixed inside the shroud tube via the needle connector and the sealing cap. Further, the storage tube is made of a transparent or semi-transparent material, for example, glass or food-grade plastic; and an observation hole 8 for observation of the storage tube is disposed in a side wall of the shroud tube.

Further, retaining lugs 16 are symmetrically disposed on an outer side wall of the sealing cap; wherein an arc surface 17 is defined on a bottom portion of the retaining lug. A through hole 6 allowing the pushing rod to be pushed or pulled is disposed in the sealing cap, wherein an annular reinforcing stage 15 is disposed at the through hole of the sealing cap; a female thread is disposed on an inner side wall of the sealing cap; and a male thread mating with the female thread is disposed at a position of the shroud tube corresponding to the sealing cap.

One end of the pushing rod is passable through the through hole and is disposed inside the storage tube; and one end of the pushing rod extending into the storage tube is provided with a sealing plug 7 that is detachably or fixedly connected thereto. A pressing handle 18 is disposed at one end of the pushing rod not extending into the storage tube; wherein a top portion of the pressing handle is a curved surface 19 that protrudes at two ends but is recessed in a middle thereof, and a reinforcing curved surface 20 is defined at both ends of the pressing handle. The pushing rod includes an inner tube 21 and an adjusting tube 22; one end of the pushing rod is fixedly connected to the sealing plug, and the other end of the pushing rod is fixedly connected to a connecting sleeve beneath the pressing handle via thread engagement; wherein an adjusting rod sleeve is disposed on the inner tube; and a relative pressure of the adjusting tube against the sealing plug is adjusted by adjusting a connection distance between the connecting sleeve and the inner tube.

A female thread connected to a needle is disposed on a bottom portion of the needle connector. An annular boss 11 is disposed on a top portion of the needle connector; a lower sealing ring 12 is sleeved onto the annular boss; the lower sealing ring is disposed between the needle connector and the storage tube; an upper sealing ring 13 is disposed between the sealing cap and the storage tube; the upper sealing ring is sleeved onto the pushing rod; an annular stage 14 is disposed on a bottom portion of the upper sealing ring; and an outer diameter of the annular stage is the same as an inner diameter of the storage tube.

For better illustration of the technical solution according to the utility model, use and cleaning of the flavor injector are further described.

During use, the needle and the needle connector are first fixedly connected under engagement between the female thread and the male thread, the handle is pulled backwardly, and the flavors are suctioned into the storage tube under the effect of the sealing plug. The needle is inserted into food to which flavors need to be injected, the index finger and the middle finger are pressed against the arc surface of the retaining lugs, the thumb is pressed against the curved surface 19 of the pressing handle and presses the pressing handle downwardly, and the sealing plug, under the pressing force, pushes the flavors into the inside of the food.

During cleaning, the needle is taken off, the sealing cap is rotated reversely to cancel the connection between the sealing cap and the shroud tube, and then the pushing rod is pulled out and the storage tube, the lower sealing ring, and the needle connector are sequentially taken out. The pressing handle is rotated reversely to cancel the connection between the pressing handle and the inner tube, and then the adjusting rod is taken out and the connection between the sealing plug and the inner tube is canceled. Afterwards, the parts of the injector are separately cleaned. Since the parts of the injector according to the utility model are detachably connected, the flavor injector may be sufficiently and thoroughly cleaned, and after cleaning, no flavor residue is present and thus transferring of the odor and latent food safety risks are prevented.

1. A flavor injector, including: a shroud tube (1), a storage tube (2), a sealing cap (3), a pushing rod (4), and a needle connector (5); wherein one end of the shroud tube is detachably or fixedly connected to the needle connector; the storage tube is sealingly fixed inside the shroud tube via the needle connector and the sealing cap; the sealing cap is provided with a through hole (6) allowing the pushing rod to be pushed or pulled; one end of the pushing rod is passable through the through hole and is disposed inside the storage tube; and one end of the pushing rod extending into the storage tube is provided with a sealing plug (7) that is detachably or fixedly connected thereto.

2. The flavor injector according to claim 1, wherein the storage tube is made of a transparent or semi-transparent material; and an observation hole (8) for observation of the storage tube is disposed in a side wall of the shroud tube.

3. The flavor injector according to claim 1, wherein an annular stage (9) is disposed on a side wall of the needle connector; a limiting stage (10) is disposed at a position of the shroud tube corresponding to the annular stage; and the needle connector is fixedly connected to the shroud tube under engagement between the annular stage and the limiting stage.

4. The flavor injector according to claim 3, wherein an annular boss (11) is disposed on a top portion of the needle connector; a lower sealing ring (12) is sleeved onto the annular boss; the lower sealing ring is disposed between the needle connector and the storage tube; an upper sealing ring (13) is disposed between the sealing cap and the storage tube; the upper sealing ring is sleeved onto the pushing rod; an annular stage (14) is disposed on a bottom portion of the upper sealing ring; and an outer diameter of the annular stage is the same as an inner diameter of the storage tube.

5. The flavor injector according to claim 1, wherein an annular reinforcing stage (15) is disposed at the through hole of the sealing cap; a female thread is disposed on an inner side wall of the sealing cap; and a male thread mating with the female thread is disposed at a position of the shroud tube corresponding to the sealing cap.

6. The flavor injector according to claim 5, wherein retaining lugs (16) are symmetrically disposed on an outer side wall of the sealing cap; wherein an arc surface (17) is defined on a bottom portion of the retaining lug.

7. The flavor injector according to claim 1, wherein a pressing handle (18) is disposed at one end of the pushing rod not extending into the storage tube; wherein a top portion of the pressing handle is a curved surface (19) that protrudes at two ends but is recessed in a middle thereof, and a reinforcing curved surface (20) is defined at both ends of the pressing handle.

8. The flavor injector according to claim 1, wherein a female thread connected to a needle is disposed on a bottom portion of the needle connector.

9. The flavor injector according to claim 1, wherein the pushing rod includes an inner tube (21) and an adjusting tube (22); one end of the pushing rod is fixedly connected to the sealing plug, and the other end of the pushing rod is fixedly connected to a connecting sleeve (23) beneath the pressing handle via thread engagement; wherein an adjusting rod sleeve is disposed on the inner tube; and a relative pressure of the adjusting tube against the sealing plug is adjusted by adjusting a connection distance between the connecting sleeve and the inner tube.
